(19) United States
(12) Patent Application Publication
(10) Pub. No.: US 2005/0095568 A1
(43) Pub. Date: May 5, 2005

(54) Print media apparatus using cards

(75) Inventors: Thomas Musolf, Mountain View, CA (US); Peter Milford, Los Gatos, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LeapFrog Enterprises, Inc., Emeryville, CA (US)

(21) Appl. No.: 10/966,438

(22) Filed: Oct. 15, 2004

Related U.S. Application Data
(60) Provisional application No. 60/511,824, filed on Oct. 15, 2003.

(51) Int. Cl. G09B 5/00

(52) U.S. Cl. 434/308

(57) ABSTRACT

A print media apparatus includes a platform unit that includes a platform, an electronic position determining system that includes a processor unit, and a memory device. The memory device includes code for outputs related to print elements. A print medium is provided that may include one or more print elements and a card is also provided for the print medium that includes one or more print elements. A user may insert the card in a card receiver on the print medium. The card may be recognized by the processor unit. When print elements are selected, an output for code associated with the print element and the inserted card is determined. The output may be outputted by the print medium apparatus.

### CROSS-REFERENCES TO RELATED APPLICATIONS

This application claims priority from co-pending U.S. Provisional Patent Application No. 60/511,824 filed Oct. 15, 2003, entitled “PRINT MEDIA APPARATUS USING CARDS,” which is hereby incorporated by reference, as if set forth in full in this document, for all purposes.

### BACKGROUND OF THE INVENTION

Embodiments of the present invention relate to print media and more specifically to a print medium that uses cards.

Interactive learning systems help a student remember and learn about subjects. Content may be provided on a printed medium, such as a book. A student may then interact with pictures displayed on pages of the book. In response, the interactive learning system may output audio content associated with the pictures. For example, a student may touch figures pictured on the book and have certain audio content associated with the figures audibly outputted.

The student may use the book over and over again. During each use, the pictures on the pages and corresponding outputs remain constant. Accordingly, the interactive learning system could be improved. For example, if the student receives the same outputs for the same pictures on the same pages found in a book, a student's interest in the book may diminish over time. Accordingly, the student may stop using the book and possibly the interactive learning system altogether.

Embodiments of the present invention address the above problems and other problems, individually and collectively.

### SUMMARY OF THE INVENTION

Embodiments of the present invention generally relate to a print medium that uses cards. In one embodiment, a print media apparatus includes a platform unit that includes a platform, an electronic position determining system that includes a processor unit, and a memory device. The memory device includes code for outputs related to print elements. A print medium is provided that may include one or more print elements. Cards are also provided for the print medium where the cards may include print elements.

A user may place a card on the print medium using a card receiver. The card may be recognized by the processor unit. When print elements are selected, an output for code associated with the print element and the inserted card is determined. The output may be outputted by the print medium apparatus.

In one embodiment, a media apparatus is provided. The media apparatus comprises: (a) a platform unit including (i) a platform, (ii) a memory device for the platform, the memory device comprising code for an output related to a graphic element, and (iii) an output device configured to output the output; (b) a medium comprising the graphic element disposed on the platform; and (c) a card on the medium.

In another embodiment, a print media apparatus is provided. The print media apparatus comprises: (a) a platform unit including (i) a platform, (ii) an electronic position determining system including a processor unit associated with the platform, (iii) a memory device coupled to the processor unit, the memory device comprising first code for a first output and second code for a second output, and (iv) an output device coupled to the processor unit; and (b) a print medium disposed on the platform, wherein the first output is outputted when a first card is on the print medium and the second output is outputted when a second card is on the print medium.

In yet another embodiment, a kit is provided. The kit comprises: a print medium, wherein the print medium is to be used with a platform unit; and a plurality of cards to be used with the print medium, wherein one or more outputs are outputted by an output device for the platform unit for the plurality of cards and the print medium, wherein outputs in the one or more outputs depend on a card in the plurality of cards on the print medium.

In another embodiment, a method comprising the following steps is provided: receiving an input for a first card placed on a print medium; receiving a selection of a print element; determining code for a first output associated with the first card, the code for the first output being related to the print element; and outputting the determined first output.

In another embodiment, a method comprising the following steps is provided: placing a print medium comprising a first print element on (a) a platform unit including (i) a platform, (ii) an electronic position determining system including a processor unit associated with the platform, (iii) a memory device coupled to the processor unit, and (iv) an output device coupled to the processor unit; and placing a card on the print medium.

In another embodiment, an apparatus is provided. The apparatus comprises: a card sensing strip; a transferable memory device coupled to the card sensing strip; and a card to be read by the card sensing strip.

A further understanding of the nature and the advantages of the inventions disclosed herein may be realized by reference of the remaining portions of the specification and the attached drawings.

### BRIEF DESCRIPTION OF THE DRAWINGS

FIG. 1A shows a plurality of cards according to one embodiment of the present invention;

FIG 1B shows a print medium according to one embodiment of the present invention;

FIG. 1C shows a memory device according to one embodiment of the present invention;

FIG. 2 shows an interactive print media apparatus;

FIGS. 3-7 depict embodiments of a print media apparatus;

FIG. 8 depicts a simplified flowchart of a method for outputting information according to one embodiment of the present invention;

FIG. 9 depicts an example of a card according to one embodiment of the present invention;

FIG. 10A depicts an example of a page of a print medium according to one embodiment of the present invention;

FIG. 10B shows a card inserted in card receiver according to one embodiment of the present invention;

FIGS. 11A and 11B depict another embodiment of a card receiver according to one embodiment of the present invention;

FIGS. 12A and 12B depict yet another embodiment of card receiver according to embodiments of the present invention; and

FIG. 13 depicts another embodiment of card receiver according to embodiments of the present invention.

FIG. 14 depicts another embodiment of cards and card receivers according to one embodiment of the present invention.

### DETAILED DESCRIPTION OF THE INVENTION

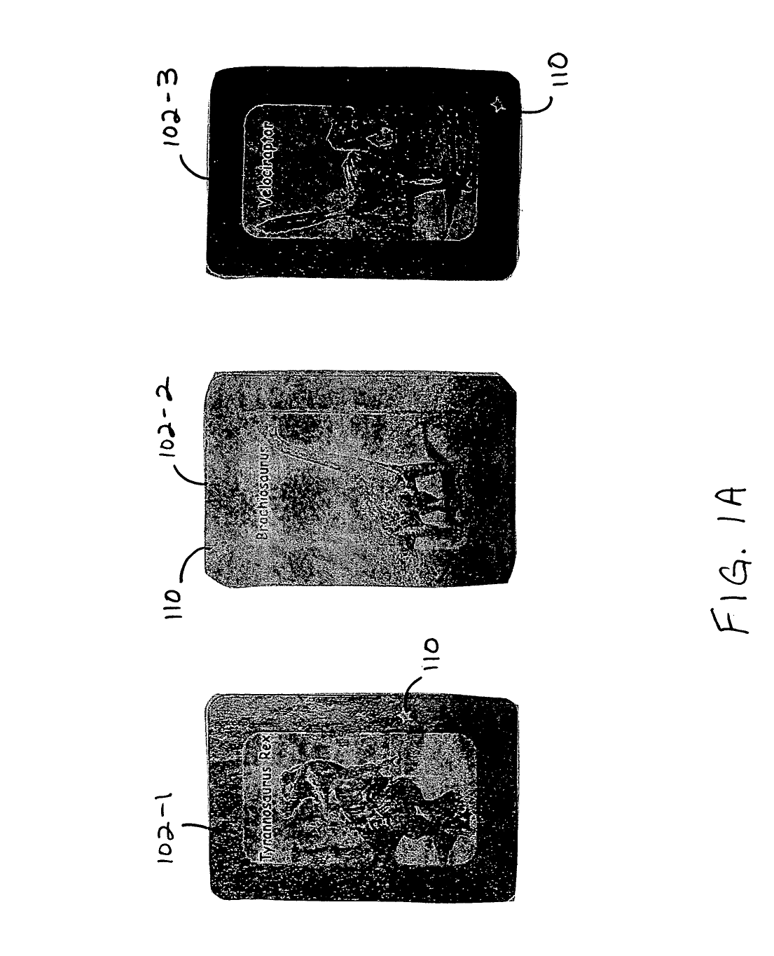

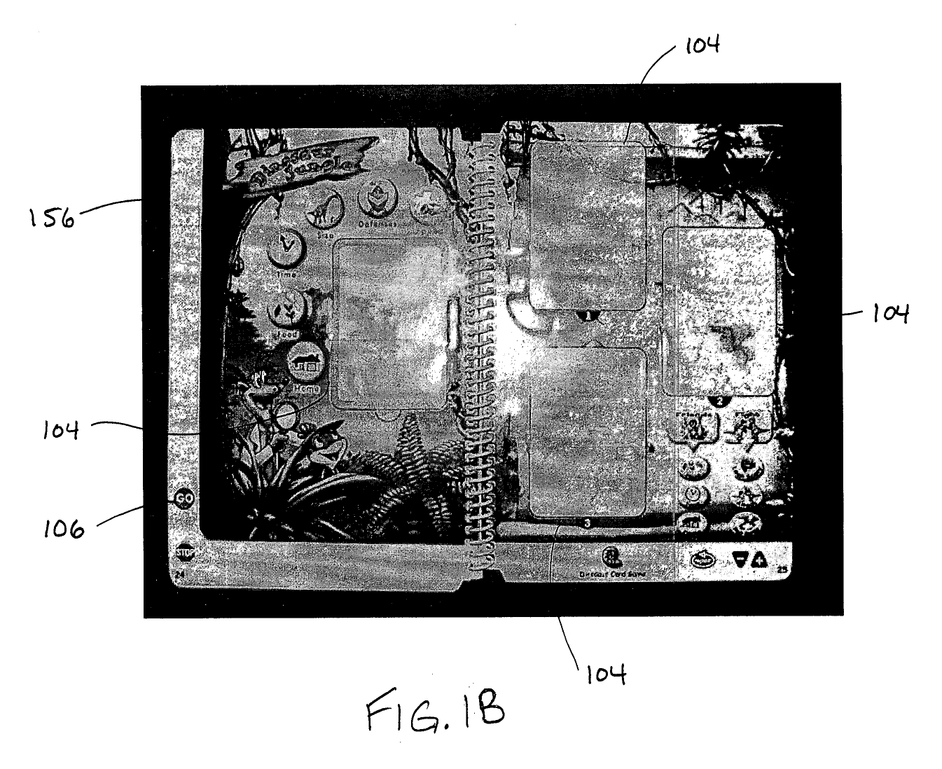

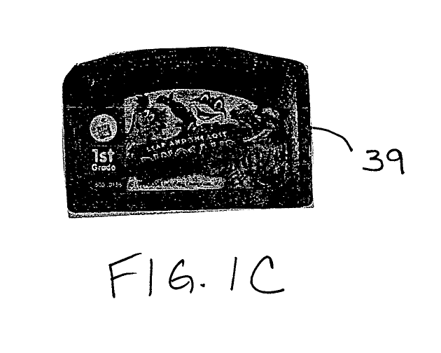

FIG. 1A shows a plurality of cards 102 according to one embodiment of the present invention. In one embodiment, any number of cards 102 may be included in a pack of cards.

Cards 102 may comprise plastic, paper, cardboard, etc. and can be colored or uncolored (i.e., transparent). Cards 102 may be a single sheet or multiple sheets bound together (e.g., a book). Cards 102 may be any size. For example, a card 102 may be approximately 2.2 inches by 3.25 inches by 0.015 inches (L×H×W).

Cards 102 may include various print elements pictured on each card 102. Print elements may be any information pictured or printed on cards 102. The print elements printed on cards 102 may vary from card to card. For example, each card 102 may include a different picture. Also, a pack of cards 102 may include cards 102 that have related print elements. For example, a pack of cards 102 may include pictures of different dinosaurs on each card 102. As shown in FIG. 1A, a card 102-1 shows a picture of a “Tyrannosaurus Rex” print element, card 102-2 shows a picture of a “Brachiosaurus” print element, and card 102-3 shows a picture of a “Velociraptor” print element.

Other elements may be included on cards 102. For example, cutouts and different textures may be provided on cards 102. In one example, print elements may be raised on cards 102. Additionally, active or passive elements, such as RFIDs, resistors, magnetic strips, computer chips, or other elements useable to assist in card sensing may be included on cards 102.

In one embodiment, cards 102 include printed identifiers 110, which are used to identify each card 102. As shown, printed identifiers 110 are located in different positions. As will be described in more detail below, the positioning of printed identifiers 110 may be used to identify a card 102. Other methods of identifying a card 102 will also be described below.

FIG. 1B shows a print medium 156 according to one embodiment of the present invention. Print medium 156 may include a print medium identifier 106 and one or more card receivers 104 and be made of plastic, wood, paper, etc.

Print medium 156 may be one or more of pages of a book, a book, a single sheet, a pamphlet, etc. The pages of the book may be made of any material, such as paper, plastic, etc. In another embodiment, print medium 156 may be a sheet of any material. The material may be, for example, rigid, flexible, etc.

It will be understood that print medium 156 may alternatively be an electronic display medium in other embodiments. In these other embodiments, cards could be placed on an electronic display medium of a hand-held educational device. The cards can enhance the content already provided by the electronic display medium. The electronic display medium may be of the type described in U.S. patent application Ser. No. 10/775,830, filed on Feb. 9, 2004, which is herein incorporated by reference in its entirety for all purposes. U.S. application Ser. No. 10/775,830 discloses a hand-held apparatus including a direction pad and a stylus. Thus, although “print elements” are described in detail, it is understood that other types of graphic elements such as electronic graphic elements can be provided on the platform unit in other embodiments of the invention. Accordingly, the graphic elements used in embodiments of the invention can be present in any suitable form.

Card receivers 104 are configured to receive cards 102. As shown, card receivers 104 are in the form of pockets. A pocket may be configured to be substantially the size of card 102. In one embodiment, a pocket may be approximately 2.75 inches by 2.185 inches (L×H). The depth of the pocket may be approximately 0.078 inches also. The pocket may also be transparent in some embodiments. Accordingly, when a card 102 is inserted in the pocket, a user can still view information on card 102. Although the above card receivers 104 are described, it will be understood that other card receivers 104 will be appreciated by a person skilled in the art, some of which are described below. For example, corner holder structures such as those used in photo albums can be card receivers. Also, a user may hold a card in an area designated as a card receiver 104. For example, a rectangle indicating where a card should be held may be found on print medium 156. In addition, card receivers 104 may be a recess. The recess may be an indentation where a card 102 may be placed. Also, card receivers 104 may be virtual in that cards 102 may be detected when they are placed on print medium 156. In this sense, a card receiver 104 may not include a physical receiving structure. The act of detecting cards 102 when they are placed on print medium 156 provides a card receiver 104, however. For example, cards 102 may include RFID tags and print media apparatus 100 may include a RFID receiver used to detect the cards.

Print medium 156 also includes a number of print elements. For example, “home”, “food”, “time”, “size”, “defenses”, and “speed” print elements are shown on the left-hand side page. Also, additional print elements are found on the page, such as a picture of a dog and frog. On the right-hand page of print medium 156, additional print elements are shown as “friends”, “food”, “time”, etc. in addition to background print elements. In another embodiment, letters, numbers, colors, shapes, etc. may be provided as print elements.

Print elements may be any elements found on print medium 156 or cards 102. For example, print elements may be printed on a paper medium. Also, print elements may be included as electronic graphic elements in an electronic representation of print medium 156 and displayed on a monitor as discussed above.

FIG. 1C shows a memory device 39 according to one embodiment of the present invention. Memory device 39 includes a plurality of instructions or code adapted to direct a processor to perform a set of steps. In one embodiment, memory device 39 may be a cartridge. The cartridge allows for easy portability and transferability.

In this example, the memory device 39 is in the form of a data cartridge. The memory device could also be in other forms in other embodiments. For example, the memory device may comprise any suitable combination of internal or external ROM (read only memory) units, EEPROM (electronically erasable programmable read only memory) units, PROM (programmable read only memory) units, etc. The memory device may be in the other forms (e.g., a memory stick, CD-ROM, etc.). These memory devices may operate using any optical magnetic or electrical data storage medium.

Memory device 39 may include computer code for various outputs. The outputs provided by the interactive print media apparatus may include visual and/or audio outputs. Exemplary outputs can include letters, stories, numbers, words, phrases, jokes, music, questions, answers, prompts, sound effects, facts, etc. Audio outputs are preferred as they supplement and reinforce visual information such as letters, pictures, and numbers that may be on the sheets of the print medium.

In another example, memory device 39 may be any device that stores data. For example, memory device 39 may include data encoded in information printed on print medium 156. A device, such as a pen, may be used to scan the encoded information and determine the outputs. Further details are described in U.S. patent application Ser. No. 10/803,806, entitled Scanning Apparatus, filed Mar. 17, 2004, which claims priority from U.S. Provisional Application No. 60/456053, entitled Scanning Apparatus and Method for Scanning Print Elements, filed Mar. 18, 2003, both of which are incorporated by reference for all purposes.

In one embodiment, different cards 102 may have different outputs for the same print elements. For example, if a Tyrannosaurus Rex card 102-1 is inserted in card receiver 104, and the print element “food” is selected, an output may be “The Tyrannosaurus Rex eats 500 pounds of meat.” If the Velociraptor card 102-3 is inserted in card receiver 104, and the print element “food” is selected, an output may be “The Velociraptor hunted plant eating carnivores.” Accordingly, the same print element may yield different outputs. Thus, memory device 39 includes code for print elements that correspond to different cards 102.

Print medium 156, cards 102, and memory device 39 may be used with a print media apparatus. In one example, print medium 156 may be placed on a print media apparatus. Print medium 156 and cards 102 may include one or more print elements. The print media apparatus is then configured to associate code for outputs with the one or more print elements.

A card 102 may then be inserted into card receiver 104 of print medium 156. The print media apparatus can determine which card 102 is inserted in card receiver 104. This determination may be made automatically or with the help of a manual selection by a user. When print elements are selected on cards 102 or print medium 156, the print media apparatus is configured to associate code for outputs for the print elements based on a card 102 identified.

A user may interact with the print elements on print medium 156 and cards 102. Different cards 102 may be placed on print medium 156. Different outputs associated with the print elements may then be determined based on the different cards 102 that are placed on print medium 156. By having different cards 102 placed on print medium 156, the content on a page of print medium 156 may be effectively changed. For example, a Tyrannosaurus Rex card on a page may mean that outputs should be different for print elements on the page from if a Velociraptor card is on the page. Accordingly, placing different cards on a print medium 156 changes the content of a page without changing the drawings on the page.

Embodiments of the present invention will now be described. Section I will describe the print media apparatus in more detail. Section II will describe embodiments of cards 102, print medium 156, and memory devices 39.

I. Interactive Print Media Apparatuses

Although the following platform unit is described, it will be understood that other suitable platform units may be provided. For example, a platform unit may include a computing device with a touchscreen, a print medium holder with an interactive pen, etc. In another example, a platform unit where data is encoded in information on print medium 156 may be provided. A device, such as a pen, may then be used to scan the encoded information and outputs may be determined based on the encoded information. Further details are described in U.S. patent application Ser. No. 10/803,806, entitled Scanning Apparatus, filed Mar. 17, 2004, which claims priority from U.S. Provisional Application No. 60/456053, entitled Scanning Apparatus and Method for Scanning Print Elements, filed Mar. 18, 2003, both of which are incorporated by reference for all purposes. In yet another example, a platform unit may be a computer with a digitizing tablet. The digitizing tablet may be used to send signals to the computer. For example, sensors may detect where a user is touching on the tablet and signals are sent to the computer. The computer may then process the signals as if a user is touching the screen of the computer. Cards 102 may be placed on the tablet and automatically identified using the computer.

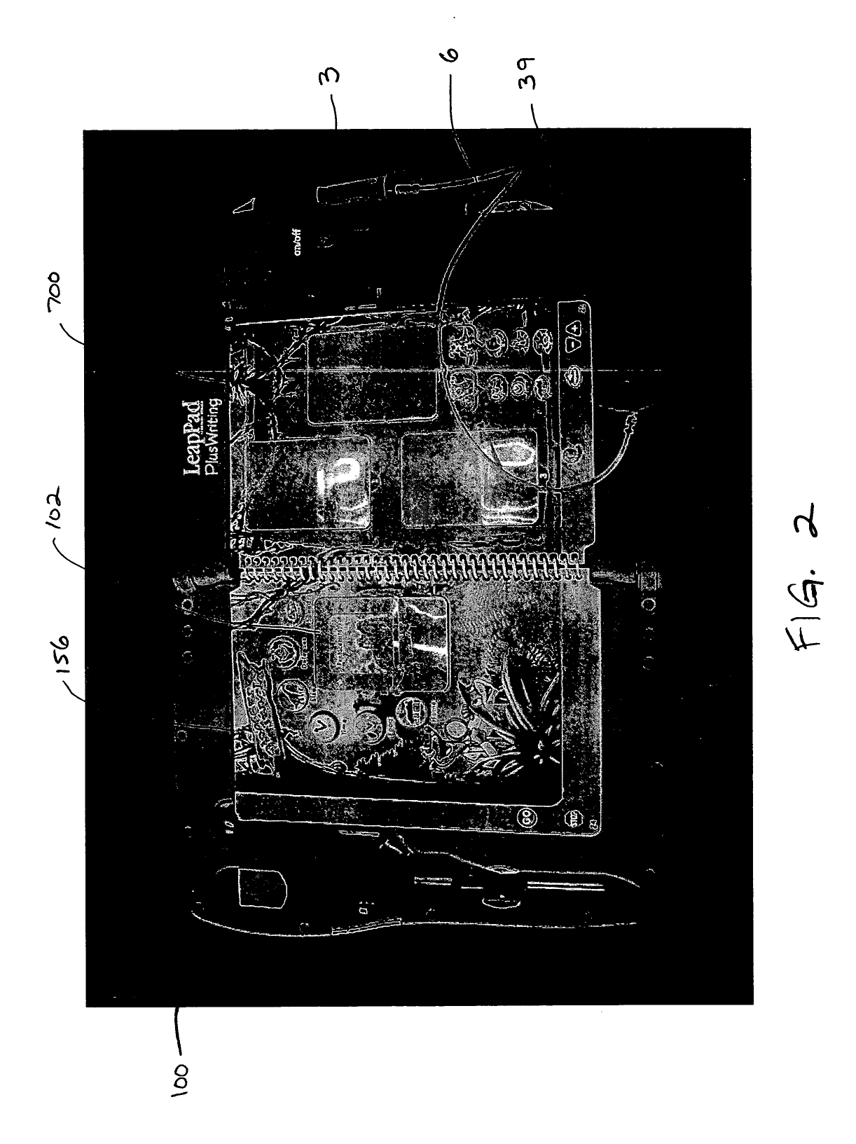

FIG. 2 shows an interactive print media apparatus 100. The interactive print media apparatus 100 includes a platform 700, a stylus 3 that is mechanically and electronically coupled to the platform 700 via a wire 6, and a memory device 39 in the form of a data cartridge. A print medium 156 is on the platform 700. The memory device 39 can plug into a recess (not shown) in the platform 700.

When it is plugged into the platform 700, the memory device 39 is in communication with an electronic position location system in the platform 700. The memory device 39 may contain code for various audio outputs corresponding to various print elements on the print medium 156 and cards 102. Such audio outputs may include interpretations of print elements, sound effects associated with print elements on a print medium, etc. The memory device 39 may comprise code for outputs where the code is related to a print element and card 102.

In this example, the memory device 39 is in the form of a data cartridge that is external to the platform 700. The memory device could also be internal to the platform in other embodiments. For example, the memory device may comprise any suitable combination of internal or external ROM (read only memory) units, EEPROM (electronically erasable programmable read only memory) units, PROM (programmable read only memory) units, etc. The memory device may be in the other forms (e.g., a memory stick, CD-ROM, etc.).

In embodiments of the invention, the print medium 156 can comprise plastic, paper, cardboard, etc., and can be colored or uncolored. The print medium 156 can be a single sheet (e.g., like a worksheet or photograph) or a book. The book can have any suitable number of pages, and may include a binder such as a spiral or a ring binder. Each sheet (e.g., in a book) may also have any suitable size. For example, each sheet can have a standard size such as 5×7, 8.5×11, 8×14, or A4.

Any suitable number or types of print elements can be on the one or more sheets of the print medium 156 and cards 102. Exemplary print elements include drawings and portions thereof, words, phrases, portions of words, phonograms, shapes, pictures (e.g., photographs) and portions thereof, characters, symbols, maps, letters, numbers, shapes, drawings, blanks, boxes, lines, arrays of indicia (e.g., an array of letters, numbers, or both) etc.

As discussed above, the print medium 156 and the outputs that are stored as code in the memory device 39 can teach a user about one or more subjects at one or more skill levels. Accordingly, some embodiments of the invention are directed to kits that contain print media and memory devices that can be used with the described interactive platforms. For example, a “kit” may comprise a print medium and may also include cards 102 and an optional corresponding memory device 39 with code for audio outputs that correspond to the print medium 156 and cards 102. The kit may be adapted to teach a user about a particular subject(s) (e.g., dinosaurs) at a particular skill level (e.g., first grade).

An output device (not shown) can be in the platform 700 and is also operationally coupled to the electronic position location system. The output device can be an audio output device such as a speaker or an earphone jack. The output device could alternatively be a visual output device such as a display screen.

The platform 700 can have a surface on which the print medium 156 is placed. The platform 700 may house parts of the electronic position location system. The system may include a processor and array of electrical elements (not shown) that are underneath the surface of the platform. The electrical elements can be antennas such as those described in U.S. Pat. Nos. 5,877,458 or 5,686,705, and U.S. patent application Ser. Nos. 09/574,599 and 60/200,725. All of these patents and patent applications are incorporated herein by reference in their entirety for all purposes. The antennas can transmit signals that can be received by the stylus 3. The stylus 3 can have a receiving antenna (this may be part of the system). When the stylus 3 is over the surface, the stylus 3 receives a particular signal that is associated with the electrical element underneath the stylus 3. Then, the position of the stylus 3 relative to the surface can be determined. The stylus 3 could be used to interact with the various print elements on the print medium 156 and cards 102 that are on the platform 700. The electrical elements may be transmitting antennas that regularly transmit signals that are received by the stylus 3, or may be receiving antennas that receive a signal from the stylus 3.

Electrical elements that are transmitting antennas are described in detail. However, in other embodiments, pressure-sensitive switches could be used. Apparatuses with pressure sensitive switches are described in U.S. Pat. No. 6,608,618, filed on Jun. 20, 2001, which is herein incorporated by reference in its entirety.

Some or all of the electrical elements in the array of electrical elements can be pre-assigned to retrieve and provide specific outputs for the user so that a user receives a particular output when selecting a print element that is located over a particular electrical element. In addition, some of the electrical elements can be pre-assigned to indicate that a different sheet with different print elements is on the base unit when they are activated. For example, once an electrical element underneath a “Go” circle 106 on a sheet is activated, the electronics in the platform 700 can determine which page of a multi-page print medium is being displayed to the user. The “Go” circle 106 may be used to identify a page that is being used on print medium 156. Accordingly, print media apparatus 100 knows to output content for that page. Additionally, once an electrical element underneath a star (“*”) on a card 102 is activated, the electronics in the platform 700 can identify which card 102 is inserted in a card receiver 104. A processor can reprogram the interactive apparatus so that the electrical elements in the array are re-assigned to retrieve outputs associated with the print elements in the new sheet and card 102.

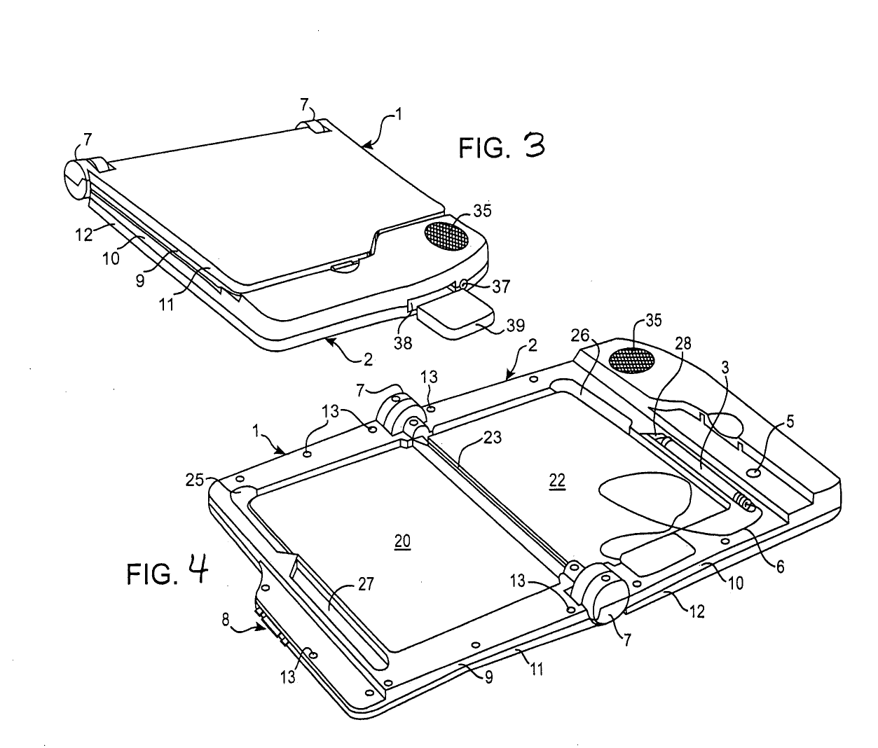

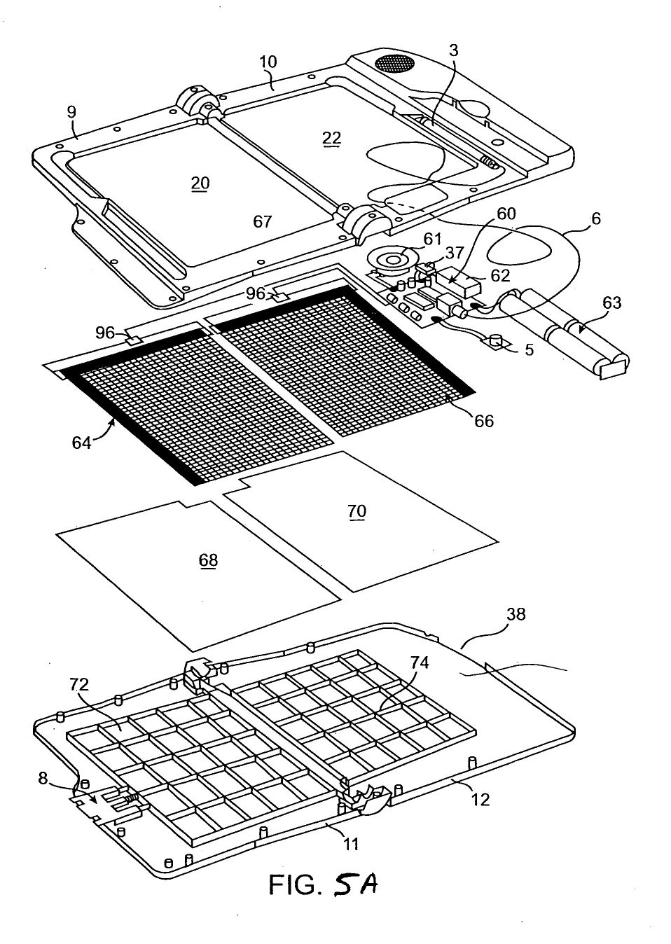

Some components of a preferred interactive print media apparatus are shown in FIGS. 3-7. Other features of a suitable apparatus are described in U.S. Pat. No. 6,668,156, filed on Feb. 5, 2001, which is herein incorporated by reference for all purposes. FIGS. 3 and 4 show a platform with first and second housing portions 1, 2 in open and closed configurations. A pair of hinges 7 connects the first and second housing portions 1, 2 of the platform. A spring-loaded latch 8 holds the housing portions 1, 2 together when closed. Both the first housing portion 1 and the second housing portion 2 comprise an upper section 9, 10 and a lower section 11, 12. The upper sections 9, 10 of the first and second housings 1, 2 are fixed to their respective lower sections 11, 12 with screws 13.

The upper and lower sections 9, 11 of the first housing portion 1 define a cavity within which is provided a first transmitting antenna element (not shown). The upper and lower sections 10, 12 of the second housing 2 also define a cavity. The second housing portion 2 can house a loudspeaker and processor.

The upper surface of the upper section 9 of the first housing portion 1 has a rectangular recess 20. An identical rectangular recess 22 is provided on the upper surface of the upper section 10 of the second housing portion 2. These rectangular recesses 20, 22 lie adjacent to one another with the long sides of the rectangular recesses being separated by a small gap 23. Together, the rectangular recesses 20, 22 provide a surface on which a book having, for example, a spiral binding (not shown) can rest. Transmitting first antenna elements are located immediately beneath these rectangular recesses 20, 22. Provided along the edges of the rectangular recesses 20, 22 remote from the gap 23 are thumb grooves 25, 26. The thumb grooves 25, 26 provide means by which a user is able to access the corners of pages of a book resting on the rectangular recesses 20, 22.

Adjacent to the thumb grooves 25, 26 further along the long sides of the rectangular recesses 20, 22 are a pair of stylus rests 27, 28. These stylus rests 27, 28 are arranged to receive a detection stylus 3. Lying in the stylus rest 28 in the upper section 10 of the second housing portion 2 is a detection stylus 3. The detection stylus 3 is connected via a wire 6 to the processor located within the part of the cavity defined by the second housing 2.

Provided in the upper section 10 of the second housing 2 is a loudspeaker grill 35, which is provided immediately above the loudspeaker, housed within the cavity. This loudspeaker grill 35 is provided at the corner of the upper section 10 of the second housing 2 next to the thumb groove 26.

In the portion of the upper section 10 of the second housing 2 adjacent to the stylus rest 28 there is an ON/OFF button 5. The ON/OFF button 5 is connected to the processor within the second housing portion 2 and provides means for activating the processor and the transmitting first antenna elements within the platform unit.

The second housing portion 2 includes a headphone jack 37 and a slot 38 arranged to receive a cartridge 39. Provided within the slot 38 is a mating interface (not shown in FIGS. 3 and 4) for receiving the cartridge 39. By inserting the cartridge 39 into the slot 38, the cartridge 39 fits into the mating interface. The processor in the second housing portion 2 can access data in the cartridge 39.

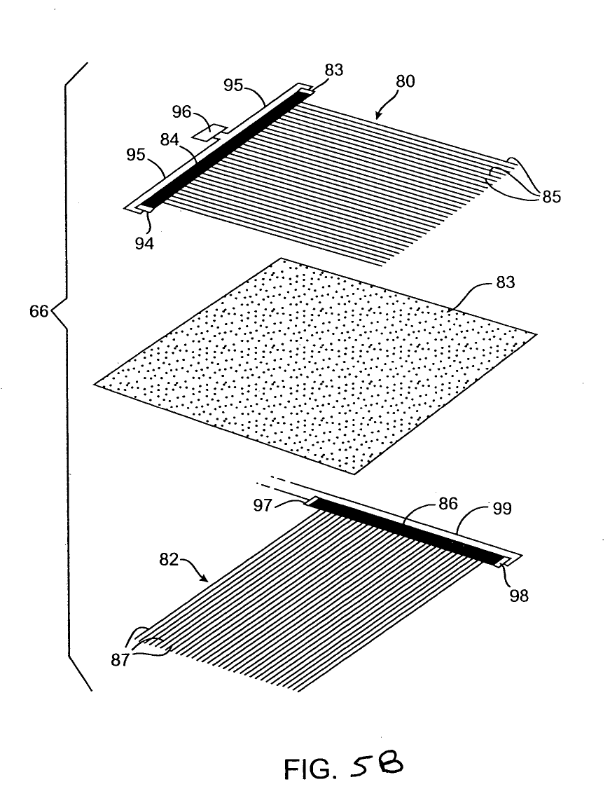

FIG. 5(a) is an exploded view of the platform unit. The processor 60 is connected to the loudspeaker 61, the ON/OFF button 5 and the headphone jack 37 and via the wire 6 to the detection stylus 3. Further the processor 60 is connected to a mating interface 62 for receiving a cartridge 39 and a set of batteries 63 for powering the processor 60.

Two first antenna elements 64, 66 are connected via cables 67 to the processor 60 enabling the processor 60 to control the timing of signals generated by the first transmitting antenna elements 64, 66. The first antenna elements 64, 66 are provided directly beneath rectangular recesses 20, 22. They are sandwiched between the underside of the upper sections 9, 10 of the first and second housings 1, 2 defining the rectangular recesses 20, 22 and sheets of cardboard 68, 70. They rest upon supports 72, 74 on the inside surfaces of the lower sections 11, 12 of the first and second housing portions 1, 2.

Referring to FIG. 5B, each first antenna element 64, 66 comprises an upper antenna 80 and a lower antenna 82 separated by an insulating acetate sheet 83. The upper antenna 80 comprises a resistive strip 84 formed by printed conductive ink, that extends along one of the short sides of a rectangle corresponding to the area defined by the rectangular recess 20, 22 beneath which the first antenna element is located. Extending away from the resistive strip 84 at right angles to the resistive strip 84 is a plurality of conductive fingers 85 also comprising printed conductive ink. These conductive fingers 85 are spaced equidistantly from one another along the length of the resistive strip 84 and run parallel to one another. The conductive fingers 85 extend from the resistive strip to a length corresponding to the extent of the long side of the rectangular recesses 20, 22.

The lower antenna 82 is disposed on the opposite side of the insulating acetate sheet 83 and comprises a second resistive strip 86. This second resistive strip 86 extends along the periphery of the area along the long side defined by the rectangular recesses 20, 22 beneath which the antenna is located. In a similar arrangement to the arrangement of the upper antenna 80, extending away at right angles from the resistive strip 86 of the lower antenna 82 are a plurality of conductive fingers 87 spaced equidistant from one another along the length of the conductive strip 86. The number of conductive fingers 85, 87 can vary depending on the desired resolution.

The conductive fingers 85, 87 of the second antenna arrangement 66 within the second housing portion 2 form an orthogonal lattice of equally spaced conductive fingers 85, 87 that extends across the entirety of the area defined by the rectangular recess 22 in the upper section 10 of the second housing portion 2 with conductive strips 84, 86 extending beyond the periphery of this area. Similarly, the conductive fingers 85, 87 of the first antenna element 64 within the first housing portion 1 define an orthogonal lattice of equally spaced conductive fingers 85, 87 extending beneath the extent of the rectangular recess 20 in the upper section 11 of the first housing portion 1. These orthogonal lattices of conductive fingers 85, 87 are used to generate electromagnetic fields in the vicinity of the surface of the recesses 20, 22 which can be detected by the detection stylus 3. They are used to determine which portions of a two-dimensional book in the rectangular recesses 20, 22 have been selected utilizing the detection stylus 3.

FIG. 5C is a detailed plan view of a first antenna element 66. FIG. 4C shows the shape of the conductive fingers 85, 87 of the first antenna element 66. When the conductive fingers 85 extend away from the conductive strip 84 of the upper antenna 80, each of the conductive fingers 85 is identical to one another and comprises a substantially rectangular strip, which has narrower portions 90 wherever the conductive finger 85 overlies one of the conductive fingers 87 of the lower antenna 82. Each conductive finger 87 of the lower antenna 82 includes a rectangular strip with wing portions 92 where the conductive finger 87 is not covered by the conductive fingers 85 of the upper antenna 80.

Provided at either end of the resistive strip 84 of the upper antenna 80 are first 93 and second 94 electrical contacts that are connected via conductive wiring 95 to an interface 96 and hence via the cable 67 to the processor 60. Similar first 97 and second 98 electrical contacts are provided at either end of the resistive strip 86 of the lower antenna 82. These contacts 97, 98 are also connected via conductive wiring 99 to the interface 96, hence via the cable 67 to the processor 60. As in the case of the upper 80 and lower 82 antennas these electrical contacts 93, 94, 97, 98 and the conductive wiring 95, 99 also comprise conductive ink printed on the surface of the acetate sheet 83.

The electrical contacts 93, 94, 97, 98 and conductive wiring 95, 99 enable electrical signals to be applied to the resistive strips 84, 86. When alternating signals are applied to the resistive strips 84, 86 this causes the conductive fingers 85, 87 connected to the resistive strips 84, 85 to generate an alternating electromagnetic field, which can be detected by the detection stylus 3. The resistive strips 84, 86 may comprise a voltage divider strip that allows signals of different voltages to transmit from each of the conductive fingers 85, 87. Further details about the voltage divider strip are in U.S. Pat. No. 6,661,405, filed May 19, 2000. In this U.S. Patent, the voltage divider strip includes a number of resistors in series. These resistors allow the conductive fingers 85, 87 to transmit signals of different voltages. Of course, other types of antenna systems may be used. For example, other embodiments that use capacitive division are described in U.S. Patent application Ser. No. 10/222,205, filed on Aug. 16, 2002.

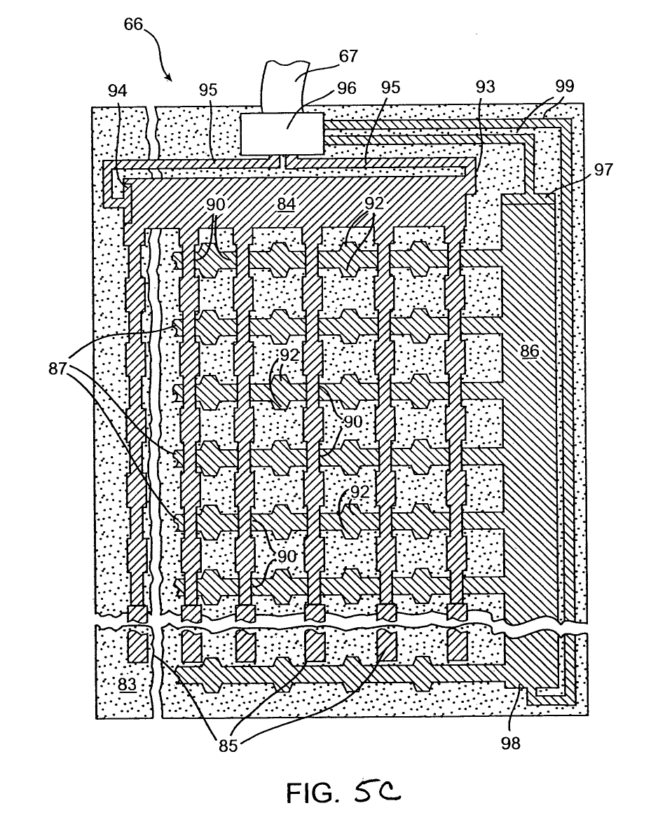

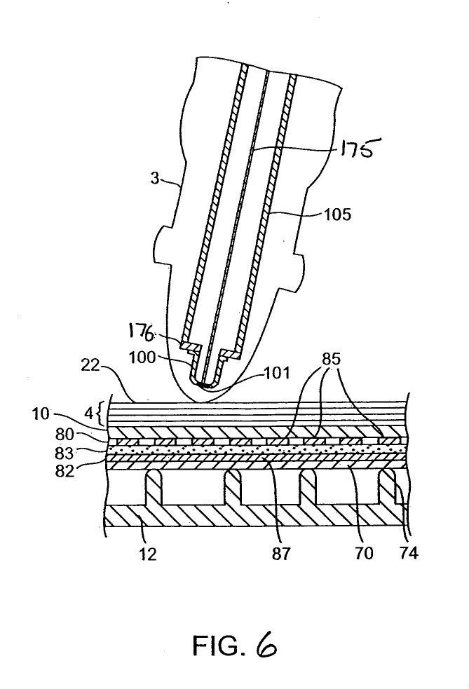

FIG. 6 is a schematic cross section of the detection stylus 3 in use detecting an electromagnetic field generated by the first antenna element 66. The detection stylus 3 is shown resting on the surface of the page of a book 4 that lies within the recess 22 in the upper section 10 of the second housing 2. Immediately beneath the upper section 10 of the second housing 2 lay the conducting fingers 85 of the upper antenna 80 of the first antenna element 66. These conductive fingers 85 are provided above the acetate insulating sheet 83 that separates the upper antenna 80 from the lower antenna 82. Disposed on the opposite side of the acetate sheet 83 are the conductive fingers 87 of the lower antenna 82. Beneath the lower antenna 82 lies the protective sheet of card 70 that it supported by the supports 74 of the lower section 12 of the second housing 2.

The distal end of the detection stylus 3 includes a brass ferule 100 that is connected via a solder bead 101 to a copper wire 175, which is connected via wire 6 to the processor 60. Provided at the end of the brass ferule 100 remote from the solder bead 101 is an insulating washer 176. The copper wire 175 extends through the center of this insulating washer 176. Shielding 105 extends within the detection stylus 3, the extent of the copper wire 175 to the insulating washer 176.

Referring to FIGS. 5A-5C and 6, alternating electric signals are applied via the electrical contacts 93, 94, 97, 98 to the resistive strips 84, 86 of the upper and lower antennas 80, 82. This causes an alternating electromagnetic field to be generated in the vicinity of the antennas 80, 82. This alternating electromagnetic field induces a voltage on the brass ferule 100 of the detection stylus 3 when the detection stylus 3 rests on the surface of a book 4 within the recess 22 adjacent to the antennas 80, 82. This electric signal is then passed via the wire 102 to the processor 60. The insulating washer 176 and shielding 105 prevent electrical signals from being induced within the wire 102 other than by variations in the electromagnetic field in the vicinity of the brass ferrule 100.

FIG. 7 is a schematic block diagram of the processor 60 and the first antenna elements 64, 66. The processor 60 comprises a controller unit 120, transmitter logic 121 and a receiver unit 122. The processor 60 may include a signal driver and a signal processor. The controller unit 120 is connected via the transmitter logic 121 to the first antenna elements 64, 66. The controller unit 120 is also connected via the receiver unit 122 via the wire 6 to the detection stylus 3. The transmitter logic 121 and receiver unit 122 are also connected to each other directly. The controller unit 120 is also connected to the headphone jack 37, the loudspeaker 61, the cartridge mating interface 62 and the ON/OFF button 5.

When the ON/OFF button 5 is pressed, this is detected by the controller unit 120 which causes the transmitter logic 121 to be activated. The transmitter logic 121 then applies electric signals to the electrical contacts 93, 94, 97, 98 of the first antenna elements 64, 66 in a sequence of frames. Referring to FIG. 5(c), in these frames, each lasting approximately 3 milliseconds, predetermined electrical signals are applied to the contacts 93, 94, 97, 98 of the transmitting antenna arrangements 62, 64. At the end of each frame a different set of signals are then applied to the contacts 93, 94, 97, 98.

In the course of a frame, an electromagnetic field is generated in the vicinity of the rectangular recesses 20, 22 in the upper sections 9, 10 in the first and second housing portions 1, 2. These electromagnetic fields induce voltage potentials in the brass ferule 100 of detection stylus 3. This signal is then passed via the wire 6 to the receiver unit 122. In one example, the voltages applied to the contacts 93, 94, 97, 98 may range between plus three volts and minus three volts. The voltage induced within the brass ferule 100 can be about 0.5 millivolts. The receiver unit 122 then processes the induced voltage and a processed signal is then passed to the controller unit 120.

The controller unit 120 then converts the processed signals received from the receiver unit 122 into signals identifying the coordinates of the portion of the page of the book 4 at which the detection stylus 3 is currently located. These coordinates are then used to select an appropriate sound stored within a sound memory either provided as part of the controller unit 120 or alternatively a sound memory provided as a memory chip within a cartridge 39 inserted within the cartridge interface 62. The appropriate sound is then output via the loudspeaker 61 or to a set of headphones via the headphone jack 37.

II. Interactive Techniques

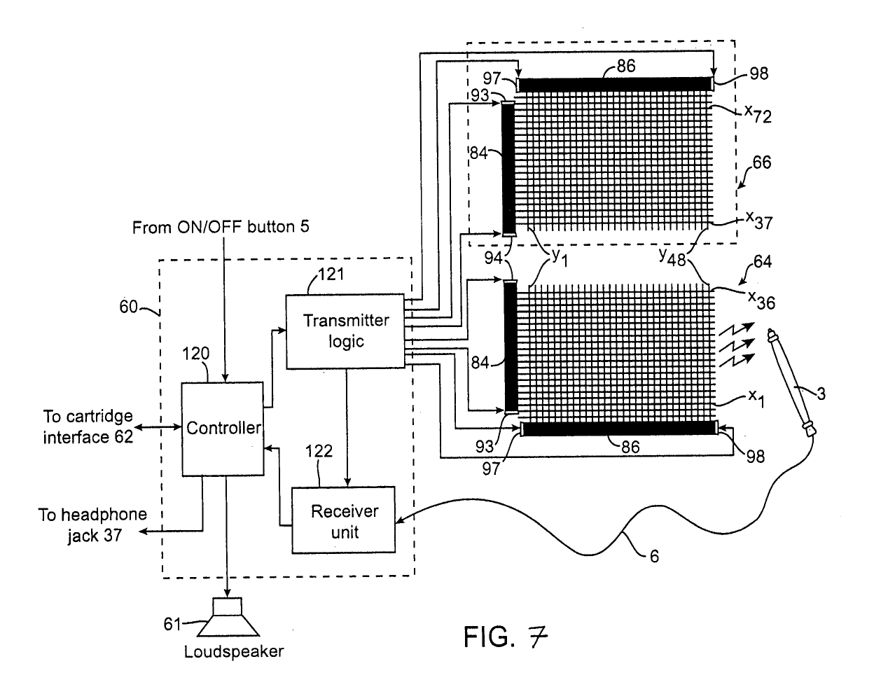

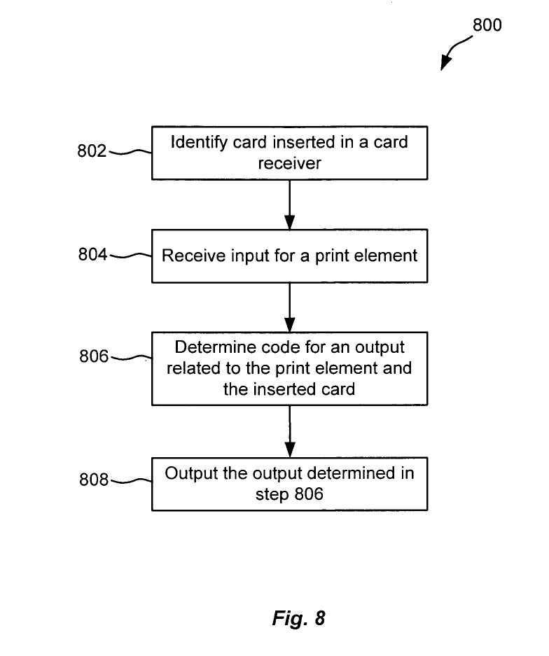

FIG. 8 depicts a simplified flowchart 800 of a method for outputting information according to one embodiment of the present invention. In one embodiment, a user may place a print medium 156 on platform 700. In another embodiment, a page may be displayed on a monitor. Upon selecting a page identifier on a page of print medium 156, a processor determines which page of print medium 156 a user has selected. In one embodiment, the page includes one or more card receivers 104. A user can then insert a card 102 in card receiver 104.

In step 802, a card 102 inserted into the card receiver 104 is identified. The card 102 inserted in card receiver 104 may be identified in many ways. For example, a printed identifier found on card 104 may be selected. Based on the location of the printed identifier, print media apparatus 100 may determine which card 102 is inserted in card receiver 104.

Also, a card sensor may read an identifier from card 104 and determine which card is inserted in card receiver 104 using the identifiers. Techniques for identifying which cards 104 are inserted in a card receiver 104 will be described in more detail below.

In step 804, print media apparatus 100 receives input for a print element selected on print medium 156 and/or the inserted card 104. For example, a user may select a print element on a page of print medium 156 and/or inserted card 102. An output is determined based on the print element selected and which card 104 is identified in step 802. For example, card 104 may include a drawing of a dinosaur. Print medium 156 may include drawings of different symbols. The symbols may be related to categories or actions, such as “home”, “food”, “time”, etc. When using print media apparatus 100, the print elements found on print medium 156 may not change. The print elements of cards 104 inserted in card receiver 104, however, may be different. This may indicate to a user that different subject matter may be output for print elements on the page and card 102. Accordingly, it is preferred that as different cards 104 are inserted in card receivers 104, different outputs may be outputted for print elements found on print medium 156 depending on a card 104 inserted in a card receiver 104.

In step 806, print media apparatus 100 determines code for an output related to the print element selected and the inserted card 102. For example, a memory device 39 includes codes for various outputs. Depending on the card 104 inserted in card receiver 104, different outputs for the print elements may be outputted. For example, if the “food” category is selected on print medium 156, different outputs for a card 104 with a drawing of a Tyrannosaurus Rex and a card 104 with a drawing of a Velociraptor may be provided based on what each traditionally eats. Accordingly, code for the print element is determined that is related to the inserted card 104 and the selected print element.

Print elements on the inserted card 104 may also be selected. Similar to above, code for an output related to the print element and the inserted card 102 is determined. The code determined depends on the inserted card 104 and the page identifier selected for print medium 156. For example, different outputs for different pages may be provided for a card 104. If a first page is an informative page about a dinosaur, the output for the print element on the inserted card 104 may be general information on the dinosaur. A second page may be a page with games and the output for the same print element for card 104 may have to do with a game being played.

In step 808, print media apparatus 100 outputs the output. For example, the first output may be audibly announced through a speaker. Also, the output may be displayed on a display.

Print media apparatus 100 may determine which card 104 is inserted in a card receiver 104 in many different ways. Different embodiments of cards 102 and card receivers 104 and how print media apparatus 100 identifies an inserted card 102 in a card receiver 104 will now be described.

FIG. 9 depicts an example of a card 102 according to one embodiment of the present invention. As shown, card 102 includes a printed identifier 110. Printed identifier 110 may be any indication on card 102. For example, printed identifier 110 may be a star “*” symbol, a “go” circle, a “touch here” symbol, a “bulls eye”, etc. The indication indicates to a user that this is a printed identifier 110 that should be selected. Also, print media apparatus 100 may direct a user to touch printed identifier 110 using audio and/or visual output. For example, an output may be “Insert a card in a pocket and touch the star found on the card.”

Examples of “star” printed identifiers 110 are shown in FIG. 1A. Cards 102-1, 102-2, and 102-3 each have star symbols in different locations. When a card 102 is inserted in card receiver 104, and the star symbol is selected, print media apparatus 100 determines the location selected. The location is then used to determine which card 102 is inserted in card receiver 104. If star symbols for cards 102 are located in different positions on the cards and the cards 102 are aligned by a card receiver 104 in the same position, then the cards 102 may be identified based on the position of the printed identifier 110 selected by a user.

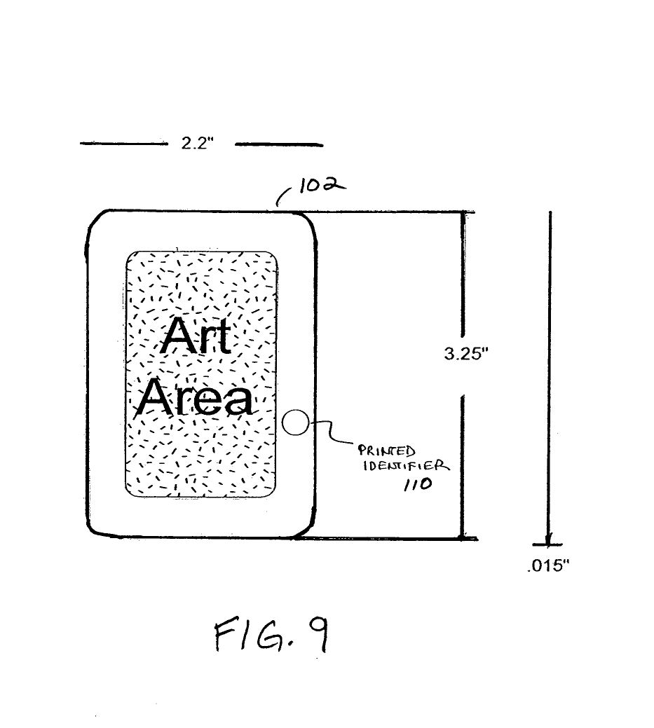

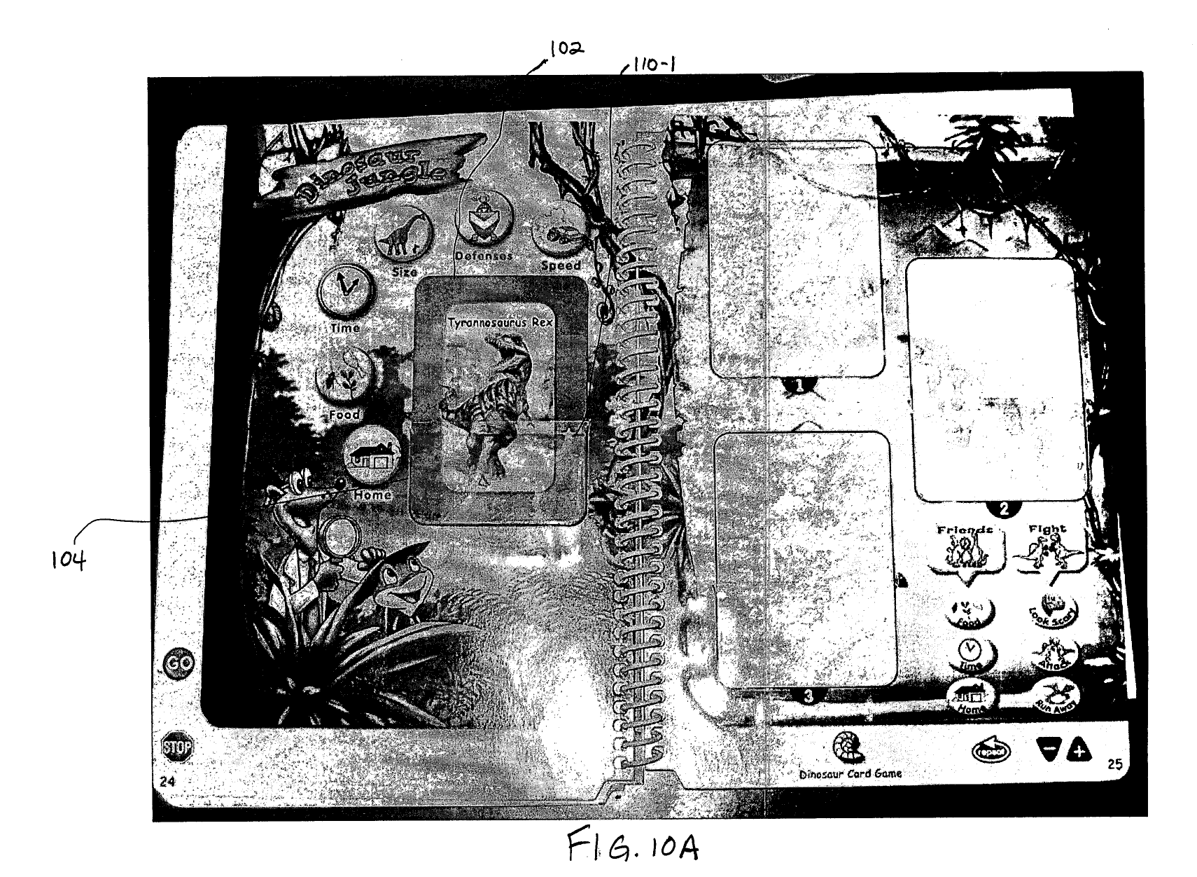

FIG. 10A depicts an example of a page of print medium 156 according to one embodiment of the present invention. As shown, the page includes a card receiver 104 in the form of a pocket.

The pocket is configured to hold and align card 102 when it is inserted into the pocket. Thus, when a card 104 is inserted in the pocket, the card is firmly held in a position. In one embodiment, the pocket is also transparent such that all of card 104 may be viewed through the pocket. The card then appears to be part of the content shown on print medium 156.

In one embodiment, when a card 102 is placed in a position on print medium 156 that is placed on a platform 700, a printed identifier 110 may be selected using, for example, stylus 3. The position is detected by print media apparatus 100. Determining the position selected on platform 700 may be determined in many ways. For example, sensing features on platform 700 may sense a position that is selected.

If the pocket is in a known position, when a card 102 is inserted into the pocket, a printed identifier 110 associated with the card selected by a user. The position may then be used to determine which card 102 has been inserted in the pocket. If different cards 102 have different printed identifiers 110 in different positions, the positions may be used to identify cards 102 when they are aligned in a pocket. Thus, the pocket is used to secure card 102 on a print medium 156 such that it can be identified.

Print media apparatus 100 may be configured to determine different positions correspond to different cards 102. For example, the position of printer identifier 110 may indicate that this card 102 has been inserted into a card receiver 104.

Once the position is identified, code associated with one or more outputs may be output for the card 102 when printed elements are selected. In one embodiment, different outputs may be determined based on the inserted card 104.

Also, a page may include a plurality of pockets located in different locations on print medium 156. Depending on which card receiver 104 a card 102 is inserted into, different outputs may be determined.

As an example, referring to FIG. 10A, a “Tyrannosaurs Rex” card 102-1 is inserted in a card receiver 104. A printed identifier 110-1 is shown in a first position. When the “Tyrannosaurs Rex” card 102 is inserted in card receiver 104, a user can select printed identifier 110-1 using stylus 3. Print media apparatus 100 then senses the first position that is selected.

FIG. 10B shows a “Velociraptor” card 102-3 inserted in card receiver 104. A printed identifier 110-2 is shown in a second position. The second position is different from the first position. When the “Velociraptor” card 102 is inserted in card receiver 104, a user can select the printed identifier 110-2 using stylus 3. Print media apparatus 100 then senses the second position that is selected.

When a print element is selected, code according to an output associated with a print element and the inserted card 102 is then executed. The output may then be outputted. For example, card 102-1 is inserted in card receiver 104 and the printed identifier 110 is selected. When print elements are selected, first code for outputs related to print elements is determined for card 102-1. For example, a picture of a Tyrannosaurus Rex is displayed on the inserted card 102-1. When the picture of the Tyrannosaurus Rex is selected, an audio output of “Tyrannosaurus Rex” may be outputted. Similarly, the print element of “food” may be selected and an output may be “The Tyrannosaurus Rex could eat 500 pounds of meat in one bite.”

If card 102-3 is inserted in card receiver 104 and the printed identifier 110 is selected, second code for outputs related to print elements are determined for card 102-3. When print elements are selected, code for an output is determined for card 102-3. For example, a picture of a Velociraptor is displayed on the inserted card 102-3. When the picture of the Velociraptor is selected, an audio output of “Velociraptor” may be outputted. Similarly, the print element of “food” may be selected and an output may be “The Velociraptor hunted plant eating dinosaurs.”

In another example, referring to FIG. 10B, three card receivers 104-2, 104-3, and 104-4 are shown on a page 1004 of print medium 156. Different cards 102 may be inserted in card receivers 104-2, 104-3, and 104-4. For example, a single card 102-1 may be inserted in all three card receivers 104-2, 104-3, and 104-4 at different times. Different outputs may be outputted when card 102-1 is inserted in the different three card receivers 104-2, 104-3, and 104-4. Also, other cards (cards 102-2 and 102-3) may be inserted in card receivers 104-2, 104-3, and 104-4. The combination of cards placed in card receivers 104-2, 104-3, and 104-4 may determine an output. For example, if three cards include the letters “C”, “A”, and “T” individually, when placed in the three card receivers 104 (which may be horizontal or arranged such that “CAT” is spelled out), the output may be “CAT”. This combination causes the output of “CAT”.

Although FIGS. 10A and 10B were described with respect to a paper medium. It will be understood that the same functions may be performed with an electronic display medium. For example, a page may be displayed on a display monitor. A user may then place a card on the monitor at a designated place. A touchscreen may be provided such that a user can touch a position of the screen with either the user's finger or with a stylus. The card may thus be identified. Various outputs as described above may then be output by an output device operatively coupled to the touchscreen.

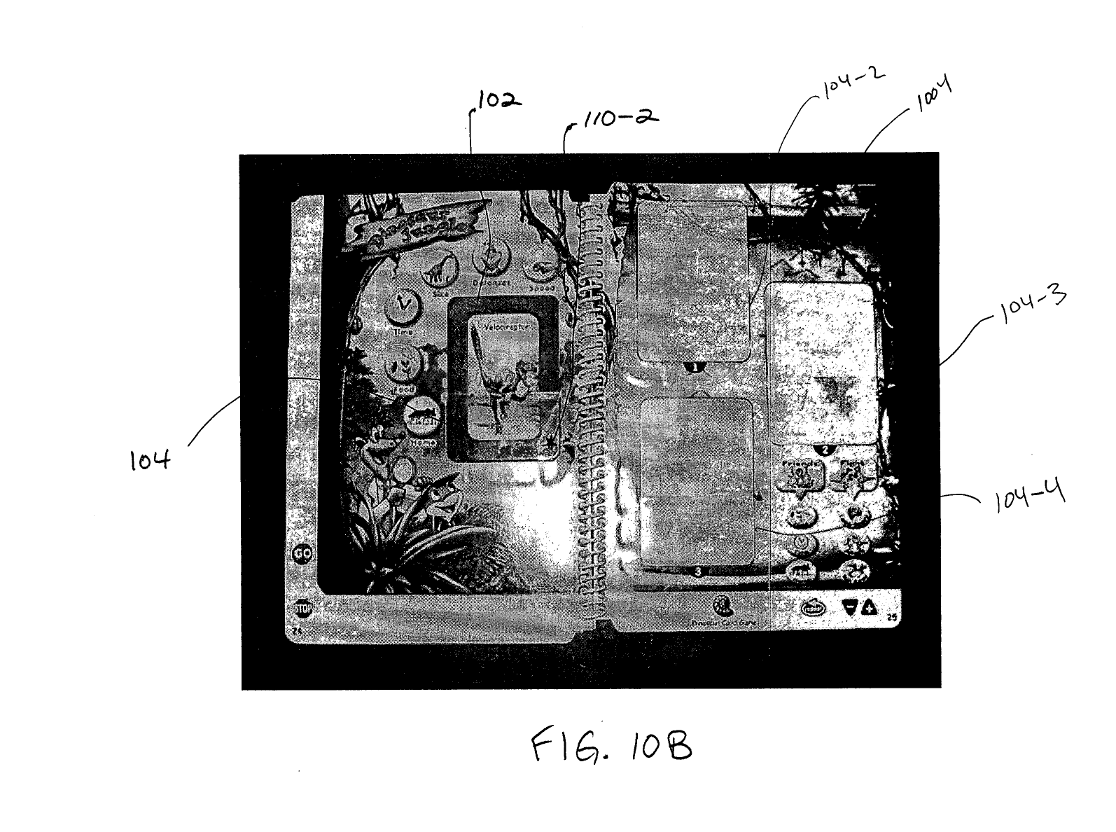

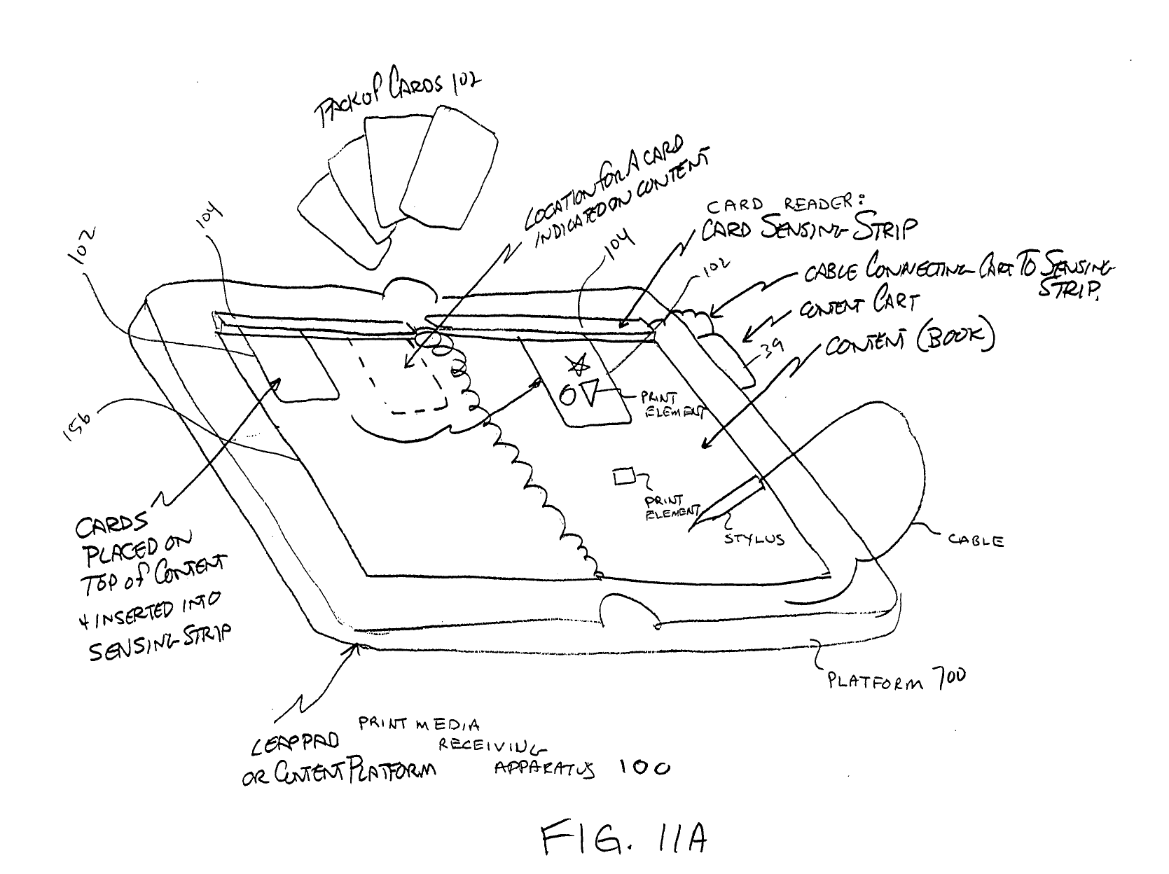

FIG. 11A depicts another embodiment of a card receiver 104 according to one embodiment of the present invention. As shown, card receiver 104 is placed on print medium 156. Cards 102 may be inserted into and secured in card receiver 104.

In this embodiment, the card receiver 104 is configured as a card reader. The card reader may be a card sensing strip that senses which card 102 is inserted in the card sensing strip. For example, different cards 102 may have different identifiers. In comparison to prior embodiments, this card receiver 104 can be used to automatically identify the card to electronics in the platform 700.

When a card 102 is inserted into the card sensing strip, print media apparatus 100 is configured to determine which card 102 is inserted into the card sensing strip. For example, an identifier may be determined from card receiver 104 and sent to memory device 39. In these embodiments, the identifiers may be in the form of holes in the cards, magnetic strips, bar codes, electrical resistors, etc. Print media apparatus 100 then uses the identifier to determine code for outputs related to print elements associated with the inserted card 102 identified. When print elements are selected, the outputs for the code may be outputted. For example, shapes may be on the card 102 and when those shapes are selected by the stylus or other pointing device, an output (audio or visual) may be provided to the user.

As shown, card receiver 104 is coupled to memory device 39 using a cable. Card sensing strip can read the identifier for a card 102. A signal can be sent to memory device 39, and to a processor inside of the platform 700. The processor may thereafter retrieve appropriate audio from the memory device 39 or another memory inside of the platform 700. Although a cable is shown connecting the memory device 39 and the card receiver 104, it will be understood that other devices for communicating an identifier may be provided. For example, a wireless connection may be provided between the card receiver 104 and the memory device 39. Also, card receiver 104 may send the identifier through platform 700 to memory device 39 in other embodiments. An appropriate electrical connection can be provided between the card receiver 104 and the electronics in the platform 700 without the cable connecting the memory device 39 and the card receiver 104. The cable may be connected to platform 700 in this embodiment, or there may be no cable at all.

FIG. 11B depicts an embodiment of a card 102 being placed in a card receiver 104 according to one embodiment of the present invention. As shown, a print medium 156 includes a number of pages and book cover. A card receiver 104 is included on the book cover. Although card receiver 104 is shown on the book cover, it will be understood that card receiver 104 may be located anywhere in print medium 156. The card receiver 104 may include a sensing strip (as previously described).

Card 102 is then placed in a card sensing strip. The card sensing strip may be configured to hold a card 102 in place when it is inserted in the strip. As shown, card 102 is held in a position over pages of print medium 156. When inserted in the strip, the strip is configured to automatically identify card 102.

The card sensing strip may be configured to identify a card 102 in many ways. For example, the card sensing strip may be a bar code reader configured to read a bar code on a card 102. An identifier encoded in the bar code would identify card 102. In another embodiment, the card sensing strip may be a magnetic strip reader configured to read a magnetic strip or a device configured to communicate with a smart card to identify card 102. Other examples are further described below.

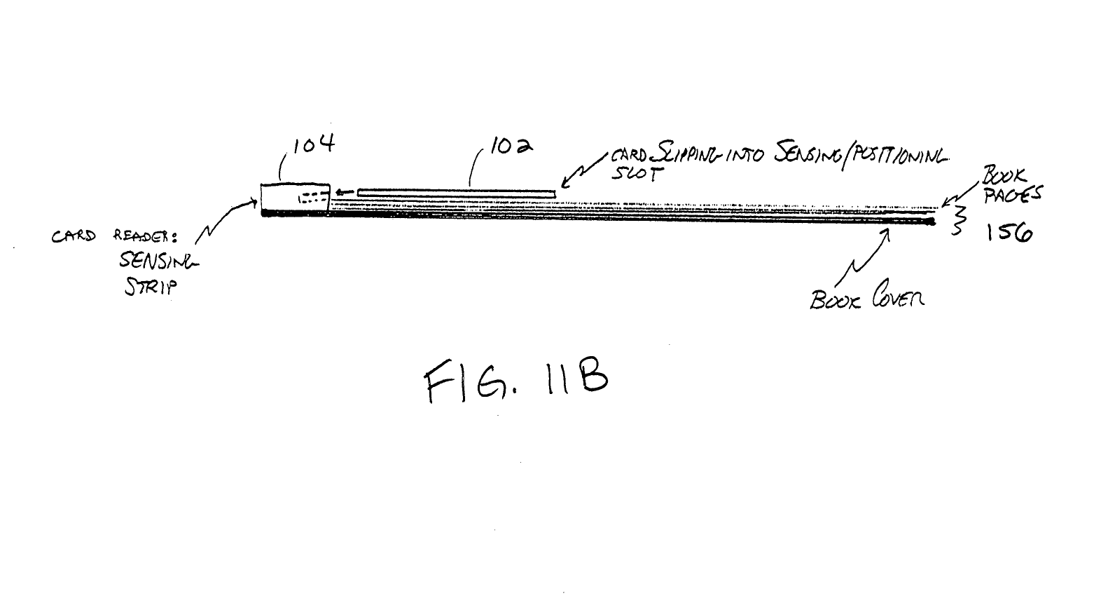

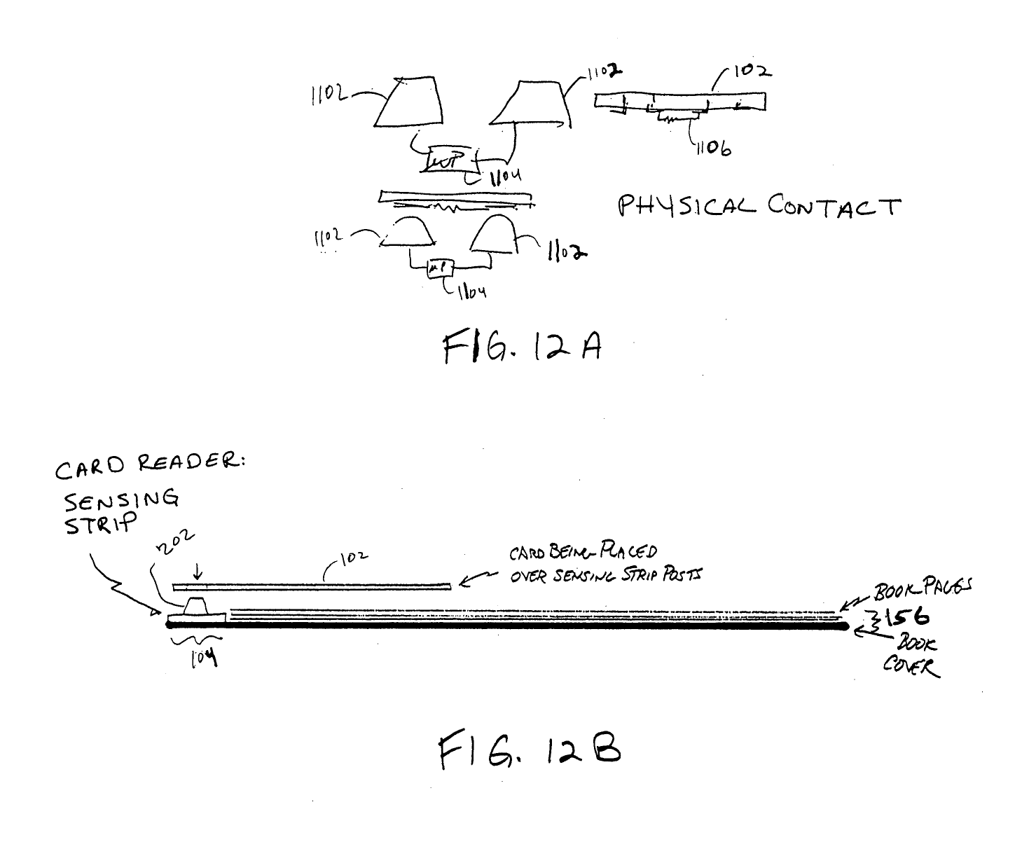

FIG. 12A depicts yet another embodiment of card receiver 104 according to embodiments of the present invention. As shown, a plurality of posts 202 are provided. Although two posts 202 are shown, it will be understood that any number of posts 202 may be provided. Posts 202 may be included on a page of print medium 156 and/or in a card sensing strip as described above.

Posts 202 are connected together by a first electrical device 1104, such as a microprocessor. Card 102 includes a second electrical device 1106, which may also be any conductive device, such as a resistor, capacitor, inductor, etc. In one embodiment, different cards 102 have second electrical devices 1106 that have different values. For example, resistors with different resistances may be provided for different cards 102. The resistors may take any suitable form. For example, conductive links with different resistors values may be used.

Card 102 may be placed on top of posts 202 such that second electrical device 1106 contacts posts 202. Accordingly, a circuit may be formed between posts 202. Depending on a value of second electrical device 1106, first electrical device 1104 outputs a value. The value may be sent to a processor which retrieves appropriate outputs from the memory device 39.

Different cards 102 may produce different values because of different second electrical devices 1106. The different values may be used to identify different cards 102.

FIG. 12B depicts an embodiment of a card 102 being placed on posts 202 according to one embodiment of the present invention. As shown, a print medium 156 includes a number of pages and book cover. A card receiver 104 is included on the book cover. Although card receiver 104 is shown on the book cover, it will be understood that card receiver 104 may be located anywhere in print medium 156.

Card 102 is then placed on posts 202 such that it contacts posts 202. Although not shown, any number of posts 202 may be provided. When contacted with posts 202, an identifier for card 102 may be automatically identified as described above.

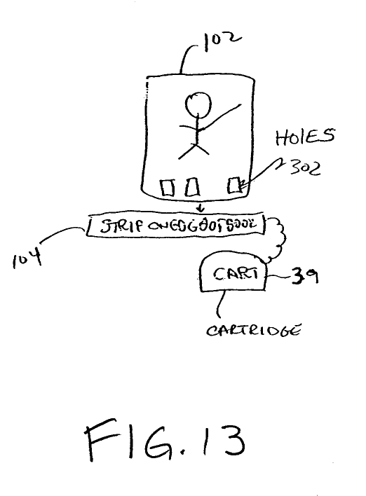

FIG. 13 depicts another embodiment of card receiver 104 according to embodiments of the present invention. As shown, card 102 includes holes 302. Holes 302 may also be slots, dimples, etc. Different identifiers may be associated with different combinations of holes 302. Thus, cards 102 may be configured to include different combinations of holes 102. Cards 102 may be identified and code for outputs associated with different cards 102 may then be determined. For example, in some embodiments, specific patterns of posts (not show, but in the strip 104) may be depressed to identify a card. The posts can be depressed by a solid portion in the card, while other posts are not depressed and pass through holes in the card.

Card receiver 104 may be included in a card sensing strip as described above. When card 102 is inserted in the sensing strip, the holes may be used by card receiver 104 to identify card 102. Descriptions of electronic mechanisms that can be used to automatically identify cards can be found in U.S. Pat. No. 5,813,861, entitled “Talking Phonics Interactive Learning Device, filed Jun. 20, 1997, which is hereby incorporated by reference for all purposes.

It should be understood that a person skilled in the art will appreciate other embodiments of card receivers 104. For example, card receivers 104 may be card detectors. A card receiver 104 is configured to detect and identify a card. Also, cards themselves may be placed randomly or on designated places on print medium 156 and their presence or position may be automatically detected. For example, print media apparatus 100 may be configured to detect when a card is placed on print medium 156.

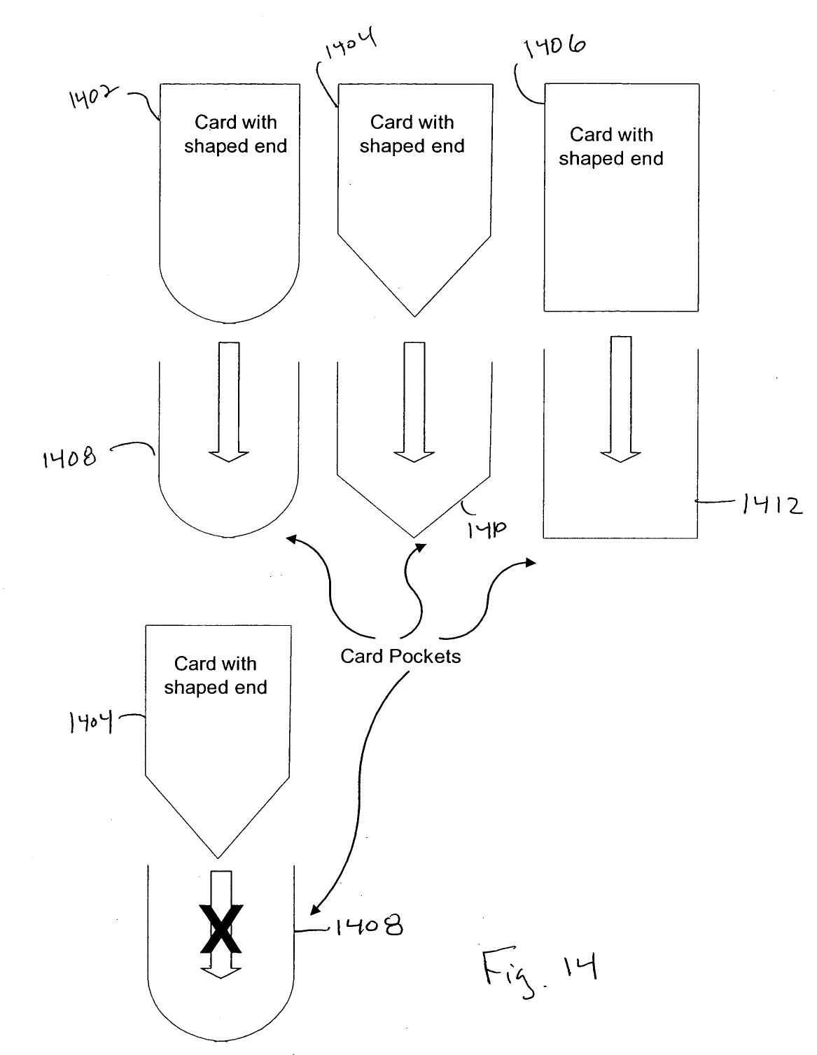

FIG. 14 depicts another embodiment of cards and card receivers according to one embodiment of the present invention. As shown, three cards 1402, 1404, and 1406 are provided. The cards have different shaped ends. Card receivers 1408, 1410, and 1412 are also provided in different shapes. The cards and card receivers are configured such that different cards can only fit into different card receivers based on the shape of the cards and card receivers.

As shown, card 1402 includes a round end that is configured to fit into card receiver 1408, card 1404 includes a pointed end that is configured to fit into card receiver 1410 and card 1406 includes a square end that is configured to fit into card receiver 1412. Cards with ends that are not configured to fit into a card receiver cannot be inserted into the card receiver with a fit that matches the shape of both the card and card receiver. For example, as shown, card 1404 with the pointed end does not properly fit into card receiver 1408 because card receiver 1408 has a round end.

Accordingly, the shapes may help a user in inserting the correct cards in card receivers. For example, vowels may be printed on cards 1402 with round ends and consonants may be printed on cards 1406 with square ends. When spelling words, the different shaped card receivers may help a user in inserting the consonants or vowels into card receivers.

Embodiments of the present invention provide many advantages. For example, different cards may be provided for a print medium. The cards may be placed on the print medium becoming part of the content found on the print medium. Based on the card placed on a page of the print medium, different outputs may be outputted. Accordingly, the content on a page of the print medium may be effectively changed by placing a card on the page.

The content of a print medium or other type of medium (e.g., an electronic display medium) may thus be enhanced using the cards. Instead of including multiple pages with pictures found on the cards, a single page may be provided and cards may be interactively placed on the page. Also, because of the interactive nature of placing different cards on a page of the print medium, a user will find the print medium more interesting. Also, in embodiments of the invention, a user can re-use the print medium with other cards so that the print medium's usefulness to the user can be extended.

The terms and expressions which have been employed herein are used as terms of description and not of limitation, and there is no intention in the use of such terms and expressions of excluding equivalents of the features shown and described, or portions thereof, it being recognized that various modifications are possible within the scope of the invention claimed.

Moreover, any one or more features of any embodiment of the invention may be combined with any one or more other features of any other embodiment of the invention, without departing from the scope of the invention.

All patent applications, patents, and publications mentioned above are herein incorporated by reference in their entirety for all purposes. None is admitted to be prior art.

The present invention can be implemented in the form of control logic in software or hardware or a combination of both. The control logic may be stored in an information storage medium as a plurality of instructions adapted to direct an information processing device to perform a set of steps. Based on the disclosure and teachings provided herein, a person of ordinary skill in the art will appreciate other ways and/or methods to implement the present invention.

The above description is illustrative but not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

1. A media apparatus comprising:
(a) a platform unit including
(i) a platform,
(ii) a memory device for the platform, the memory device comprising code for an output related to a graphic element, and
(iii) an output device configured to output the output;
(b) a medium comprising the graphic element disposed on the platform; and
(c) a card on the medium.

2. The media apparatus of claim 1, wherein the platform unit comprises a stylus coupled to the platform, wherein the stylus comprises a signal receiving conductor.

3. The media apparatus of claim 1, wherein the output device comprises a speaker and wherein the output is an audio output.

4. The media apparatus of claim 1, wherein the platform unit comprises an electronic position determining system including a processor unit associated with the platform.

5. The media apparatus of claim 1, wherein the medium comprises a print medium or an electronic display medium.

6. The media apparatus of claim 1, wherein the medium comprises an electronic display.

7. The media apparatus of claim 1, wherein the graphic element is associated with the card.

8. The media apparatus of claim 1, wherein the medium comprises a card alignment element.

9. The media apparatus of claim 1, wherein the medium comprises a card alignment element,
wherein the card alignment element is a transparent pocket.

10. The media apparatus of claim 1, wherein the medium further comprises a card reader, wherein the card reader is capable of automatically identifying the card.

11. The media apparatus of claim 1, wherein the medium comprises a card sensing strip configured to automatically identify the card.

12. The media apparatus of claim 1, wherein the medium comprises a card reader including one or more posts and the card comprises an electrical device, the card reader configured to identify the card when the electrical device contacts the one or more posts.

13. The media apparatus of claim 1, wherein the card comprises a pattern of holes, slots, or dimples, wherein a card reader of the medium is configured to identify the card based on the pattern of holes, slots, or dimples.

14. The media apparatus of claim 1, wherein the memory device comprises second code for a second output related to a second print element, wherein the second print element is located on the medium or the card.

15. The media apparatus of claim 1, further comprising a plurality of cards, wherein different cards in the plurality of cards may be placed on the medium.

16. The media apparatus of claim 1, further comprising:
a plurality of cards; and
one or more card receivers, wherein a card in the plurality of cards may be placed in each card receiver in the plurality of card receivers.

17. The media apparatus of claim 1, further comprising:
a plurality of cards; and
one or more card receivers, wherein two or more cards in the plurality of cards may be placed in a card receiver in the plurality of card receivers.

18. The media apparatus of claim 1, wherein the medium comprises a book or a sheet.

19. A print media apparatus comprising:
(a) a platform unit including
(i) a platform,
(ii) an electronic position determining system including a processor unit associated with the platform,
(iii) a memory device coupled to the processor unit, the memory device comprising first code for a first output and second code for a second output, and
(iv) an output device coupled to the processor unit; and
(b) a print medium disposed on the platform,
wherein the first output is outputted when a first card is on the print medium and the second output is outputted when a second card is on the print medium.

20. The print media apparatus of claim 19, wherein the print medium comprises a print element, and wherein the first output and the second output are related to the print element.

21. The print media apparatus of claim 19, wherein the first output is outputted when the first card is on the print medium and the print element is selected, and wherein the second output is outputted when the second card is on the print medium and the print element is selected.

22. The print media apparatus of claim 19, wherein the first card comprises a first print element and the second card comprises a second print element, wherein the first output is related to the first print element and the second output is related to the second print element.

23. The print media apparatus of claim 19, wherein the first card comprises a first print element and the second card comprises a second print element, wherein the first output is related to the first print element and the second output is related to the second print element,
wherein the first output is outputted when the first card is on the print medium and the first print element is selected, and wherein the second output is outputted when the second card is on the print medium and the second print element is selected.

24. The print media apparatus of claim 19, wherein the print medium comprises a card receiver configured to receive the first card or the second card.

25. The print media apparatus of claim 19, wherein the print medium comprises a plurality of card receivers each configured to receive the first card or the second card.

26. The print media apparatus of claim 19, wherein the print medium comprises a card receiver configured to receive the first card or the second card,
wherein the card receiver is configured to automatically identify the first card or the second card to the processor unit.

27. The print media apparatus of claim 19, wherein the print medium comprises a card receiver configured to receive the first card or the second card,
wherein the card receiver is configured to align the first card or the second card on the print medium.

28. The print media apparatus of claim 19, wherein the print medium comprises a card receiver configured to receive the first card or the second card,
wherein the card receiver is configured to align the first card or the second card on the print medium,
wherein the first card comprises a first printed identifier and the second card comprises a second printed identifier, the first printed identifier being in a first position on the first card and the second printed identifier being in a second position on the second card.

29. The print media apparatus of claim 19, wherein the print medium comprises a card receiver configured to receive the first card or the second card,
wherein the card receiver is configured to align the first card or the second card on the print medium,
wherein the first card comprises a first printed identifier and the second card comprises a second printed identifier, the first printed identifier being in a first position on the first card and the second printed identifier being in a second position on the second card,
wherein the first position of the first printed identifier identifies the first card to the processor and the second position of the second printed identifier identifies the second card to the processor.

30. The print media apparatus of claim 19, wherein the print medium comprises a card receiver configured to receive the first card or the second card,
wherein the card receiver comprises a transparent pocket.

31. The print media apparatus of claim 19, wherein the medium comprises a card sensing strip configured to automatically identify the card.

32. The print media apparatus of claim 19, wherein the platform unit further comprises a stylus coupled to the platform, wherein the stylus comprises a signal receiving conductor.

33. The print media apparatus of claim 19, wherein the output device comprises a speaker and wherein the first output is a first audio output and the second output is a second audio output.

34. The print media apparatus of claim 19, wherein the print medium comprises a book or a sheet.

35. A kit comprising:
a print medium, wherein the print medium is to be used with a platform unit; and
a plurality of cards to be used with the print medium,
wherein one or more outputs are outputted by an output device for the platform unit for the plurality of cards and the print medium, wherein outputs in the one or more outputs depend on a card in the plurality of cards on the print medium.

36. The kit of claim 35, further comprising a transferable memory device comprising code for the one or more outputs.

37. The kit of claim 35, further comprising a transferable memory device comprising code for the one or more outputs, wherein the transferable memory device is a data cartridge.

38. The kit of claim 35, wherein the one or more outputs includes outputs related to each card in the plurality of cards.

39. The kit of claim 35, wherein the one or more outputs includes outputs related to each card in the plurality of cards,
wherein the print medium comprises a print element.

40. The kit of claim 35, wherein the one or more outputs includes outputs related to each card in the plurality of cards,
wherein an output associated with the print element in the one or more outputs depends on a card in the plurality of cards being on the print medium.

41. The kit of claim 35, wherein the one or more outputs includes outputs related to each card in the plurality of cards,
wherein an output associated with the print element in the one or more outputs depends on a card in the plurality of cards being on the print medium,
wherein a first output in the one or more outputs is associated with the print element for a first card in the plurality of cards and a second output in the one or more outputs is associated with the print element for a second card in the plurality of cards.

42. The kit of claim 35, wherein a first card in the plurality of cards comprises a first print element and a second card in the plurality of cards comprises a second print element.

43. The kit of claim 35, wherein a first card in the plurality of cards comprises a first print element and a second card in the plurality of cards comprises a second print element,
wherein a first output in the one or more outputs is associated with the first print element and a second output in the one or more outputs is associated with the second print element.

44. The kit of claim 35, wherein the print medium comprises a card receiver.

45. The kit of claim 35, wherein the print medium comprises a plurality of card receivers, wherein a card in the plurality of cards may be placed in two or more of the card receivers in the plurality of card receivers.

46. The kit of claim 35, wherein the print medium comprises a plurality of card receivers, wherein two or more cards in the plurality of cards may be placed in a card receiver in the plurality of card receivers.

47. The kit of claim 35, wherein the print medium comprises a card receiver,
wherein the card receiver comprises a transparent pocket configured to align a card in the plurality of cards on the print medium.

48. The kit of claim 35, wherein the print medium comprises a card receiver,
wherein the card receiver comprises a card sensing strip configured to automatically identify a card in the plurality of cards on the print medium.

49. The kit of claim 35, wherein the one or more outputs comprises audio outputs.

50. The kit of claim 35, wherein the print medium comprises a book or a sheet.

51. A method comprising:
receiving an input for a first card placed on a print medium;
receiving a selection of a print element;
determining code for a first output associated with the first card, the code for the first output being related to the print element; and
outputting the determined first output.

52. The method of claim 51, further comprising:
receiving a second input for a second card placed on the print medium;
receiving a second selection of the print element;
determining code for a second output associated with the second card, the code for the second output being related to the print element; and
outputting the determined second output.

53. The method of claim 51, further comprising receiving a second input for a second card placed on the print medium;
receiving a second selection of the print element;
determining code for a second output associated with the second card, the code for the second output being related to the print element; and
outputting the determined second output,
wherein the print element is located on the print medium and the second print element is located on the print medium.

54. The method of claim 51, further comprising:
receiving a second input for a second card placed on the print medium;
receiving a second selection of the print element;
determining code for a second output associated with the second card, the code for the second output being related to the print element; and
outputting the determined second output,
wherein the print element is located on the card and the second print element is located on the second card.

55. The method of claim 51, further comprising:
receiving a selection of a printed identifier on the first card; and
identifying the first card based on a location of the selection of the printed identifier.

56. The method of claim 51, further comprising automatically identifying the first card placed on the print medium using a card reader.

57. A method comprising:
placing a print medium comprising a first print element on (a) a platform unit including (i) a platform, (ii) an electronic position determining system including a processor unit associated with the platform, (iii) a memory device coupled to the processor unit, and (iv) an output device coupled to the processor unit; and
placing a card on the print medium.

58. The method of claim 57, further comprising:
selecting the first print element and receiving a first audio output related to the first print element.

59. The method of claim 57, wherein the card comprises a second print element, the method further comprising selecting the second print element and receiving a second audio output related to the second print element.

60. The method of claim 57, wherein the platform unit further includes a stylus and wherein selecting the first print element includes selecting the first print element with the stylus and selecting the second print element includes selecting the second print element with the stylus.

61. The method of claim 57, wherein the print medium comprises a book or a sheet.

62. An apparatus comprising:
a card sensing strip;
a transferable memory device coupled to the card sensing strip; and
a card to be read by the card sensing strip.

63. The apparatus of claim 62, further comprising a print medium comprising a print element, the print element associated with code for an output stored in the transferable memory device.

64. The apparatus of claim 62, further comprising a print medium, wherein the card sensing strip is coupled to the print medium.

65. The apparatus of claim 62, wherein the card comprises a print element, the print element associated with code for an output stored in the transferable memory device.

66. The apparatus of claim 62, further comprising a wire coupling the card sensing strip to the transferable memory device.

67. The apparatus of claim 62, wherein the card sensing strip is configured to automatically identify the card.

68. The apparatus of claim 62, wherein the card sensing strip comprises one or more posts and the card comprises an electrical device, the card sensing strip configured to identify the card when the electrical device contacts the one or more posts.

69. The apparatus of claim 62, wherein the card comprises a pattern of holes, slots or dimples, wherein the card sensing strip is configured to identify the card based on the pattern of holes, slots, or dimples.
